(19) United States
(12) Patent Application Publication
(10) Pub. No.: US 2005/0050316 A1
(43) Pub. Date: Mar. 3, 2005

(54) Passive SSL decryption

(76) Inventor: Amir Peles, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/647,907

(22) Filed: Aug. 25, 2003

(51) Int. Cl. H04L 9/00

(52) U.S. Cl. 713/151

(57) ABSTRACT

A method and apparatus for passive probing of forwarded TCP communication sessions between a client and a server. This includes receiving forwarded data packets corresponding to the TCP communication sessions; and ordering the received data packets and reconstructing session content for each TCP session. If at least one of the communication sessions is encrypted, then: identifying an encryption scheme and a session key using the reconstructed session content; decrypting the session content, the decryption based upon the identified encryption scheme and the identified session key; and forwarding the decrypted session content to an external entity; else forwarding the reconstructed session content of to an external entity.

### BACKGROUND OF THE INVENTION

A. Field of Invention

The present invention relates generally to the field of encryption/decryption. More specifically, the present invention is related to monitoring/analyzing encrypted network data.

B. Discussion of Prior Art

Modern communication systems benefit from a myriad of network analysis applications implementing various services based upon monitoring and analyzing network traffic data. For example, security applications analyze network traffic in order to detect intrusions and identify attempts directed towards attacking a network's infrastructure. Similarly, e-commerce systems utilize billing applications to analyze network traffic data in order to bill subscribers/clients. Likewise, capacity planning applications analyze network traffic in order to detect patterns associated with resources usage and evaluate the need for further investment in equipment (or addition of services).

In a typical network analysis application, network traffic passing between a client and a server is monitored and copied (by network equipment) to the application in a manner whereby the flow of real network traffic is not disturbed. The analysis application processes the received copies of the network traffic data by parsing the content of the traffic and logging all activity.

Networks are evolving as an important business tool as business transactions are increasingly performed over networks such as the Internet. As such transactions require security and privacy, the network traffic data associated with such transactions is encrypted. The standard encryption protocol, over a network such as the Internet, is the Secure Sockets Layer (SSL) protocol.

SSL is a protocol developed by Netscape® for transmitting private documents via the Internet. SSL is an intermediate network layer, running between the TCP/IP network layer and the higher application layer (HTTP, IMAP, etc.). SSL works by using a private key to encrypt data exchanged between a client and a server. A client, such as an Internet browser (e.g., Netscape Navigator® or Internet Explorer®), supporting SSL is able to talk to a server, such as an e-commerce web site, and use the SSL protocol to obtain confidential user information, such as credit card numbers. By convention, URLs require an SSL connection start with HTTPS instead of HTTP. The SSL protocol uses cryptographic mechanisms to guarantee that the traffic cannot be decrypted within a reasonable time-frame.

A typical SSL encryption mechanism has two phases: a session establishment phase and an encryption phase. In the session establishment phase, the client and server negotiate a symmetric secret key. To negotiate, the client and server use an asymmetric process where the server uses its private key and the client uses the server's public key to exchange data. In the encryption phase, the negotiated symmetric secret key is used by both sides to encrypt and decrypt messages.

A typical SSL session between a sender and a receiver is established in four steps. In step 1, the sender sends a “HELLO” message to the receiver containing random data. In step 2, the receiver forwards the sender his/her public key embedded in a signed certificate. In step 3, the sender encrypts a shared secret key and a “CHANGE CIPHER SPEC” switch (to determine the proper cipher to use) using the receiver's public key and sends it to the receiver. In step 4, the receiver sends a reply using the shared secret key (after decrypting the information in step 3 with the receiver's private key) and a “finished” message. At this point in the session, both the sender and the receiver (or the client and the server) are ready to begin secure communications. Using the record protocol, all data that passes between the two parties are encrypted and hashed, and the recipient checks this hash upon decryption to make sure that the data has not been modified during transit.

In SSL, the communications protocol headers are passed in plaintext; only the application header and actual data sent to the application is cryptographically protected. The encryption and integrity protection for the data (and not the communications as in IPSec, which protects both) are handled by the record protocol. The negotiation of new cryptographic algorithms and keys are handled by the handshake protocol. Finally, any errors that have occurred during an SSL session are handled by the alert protocol. Additionally, SSL maintains its security state based on the session associated with a particular set of host addresses and ports.

Prior art network analysis applications suffer from a serious drawback in not being able to analyze encrypted traffic. For example, in a scenario where a client and server establish a secure communication link (e.g., via the SSL protocol) and a network device copies a network analysis application with data exchanged between the client and the server, prior art network analysis applications are unable to monitor and analyze the received data as it is encrypted, thereby rendering such applications useless in such a scenario.

As described in prior art systems in the field of analyzing encrypted traffic, a solution involves the use of encryption termination devices, wherein the functions of serving the content and encrypting it are divided. For example, an encryption termination device receives encrypted data from clients, decrypts such data, and passes the decrypted data onto servers. If traffic analysis needs to be performed, then network equipment between the encryption termination device and the servers copies the non-encrypted traffic to an analysis station running the network traffic data analysis application. This option is limiting as it affects the operation of the servers and requires modification to their application logic. Moreover, it opens a security hole as traffic needs to travel non-encrypted on part of the path between the servers and clients. This defeats the purpose of encryption.

Whatever the precise merits, features, and advantages of the above cited prior art systems, they fail to achieve or fulfill the purposes of the present invention.

### SUMMARY OF THE INVENTION

The present invention provides for a passive secure socket layer (SSL) probe, working in conjunction with network equipment and an external entity (such as a network data analysis application, a network device, etc.), wherein the network equipment: (a) facilitates the flow of data in a communication session (between a client and a server) and (b) forwards a copy of the data to the SSL probe. The data may include encrypted data in a secure communication session The passive SSL probe includes a receiver, a symmetric session key generator, a decrypter, and a forwarder. The receiver collects data packets corresponding to the forwarded data (from the network equipment), orders the received data packets for a TCP session, and reconstructs the session content. The symmetric session key generator receives the session content for each TCP session from the receiver, when encrypted identifies SSL handshake information from the session content, and identifies an encryption scheme and a symmetric session key from the SSL handshake information. The decrypter decrypts and identifies unencrypted session content for each TCP session, wherein the decryption is based upon the identified encryption scheme and the identified symmetric key. The forwarder forwards, for each session, the identified unencrypted session content to the external entity.

In an extended embodiment, the passive SSL probe further comprises a filter filtering identified unencrypted session content to isolate information pertinent to the external entity, wherein the forwarder forwards the isolated information pertinent to the external entity.

The present invention provides for a method for passive probing forwarded one or more TCP communication sessions between a client and a server, wherein the method comprising the steps of: (a) receiving forwarded data packets corresponding to the TCP communication sessions; (b) ordering the received data packets and reconstructing session content for each of the sessions; and (c) forwarding the session content to an external entity (such as a network data analysis application, a network device, etc.).

In one embodiment, at least one of the communication sessions in the above-mentioned method is encrypted (for example, via SSL), and, for each encrypted session, the method additionally comprising the steps of: (a) identifying, prior to the forwarding step, an encryption scheme and a session key from the reconstructed content; and (b) decrypting session content based upon the identified encryption scheme and session key, wherein the forwarded session content is the decrypted session content.

The present invention also provides for a method for providing passive treatment of encrypted data, wherein the method is implemented in a passive secure socket layer (SSL) probe and comprises the steps of: (a) receiving data packets corresponding to the encrypted data, wherein the encrypted data is forwarded to the SSL probe from network equipment that facilitates the flow of encrypted data in a secure communication session between a client and a server; (b) ordering the received data packets of a TCP session and reconstructing the session content; (c) identifying SSL handshake information from the session content; (d) identifying an encryption scheme and a symmetric session key from the identified SSL handshake information; (e) decrypting and identifying unencrypted session content, wherein the decryption is based upon the identified encryption scheme and the identified symmetric key; and (f) forwarding, for each session, the identified unencrypted session content to an external entity (such as a network data analysis application, a network device, etc.).

In an extended embodiment, the above-mentioned method further comprises the step of filtering identified unencrypted session content to isolate information pertinent to the external entity. Furthermore, in step (f) above, the method forwards only the isolated information pertinent to the external entity.

### BRIEF DESCRIPTION OF THE DRAWINGS

FIG. 1 illustrates a system using the present invention's passive SSL probe.

FIG. 2 illustrates a method depicting the flow of data through the present invention's passive SSL probe of FIG. 1.

FIG. 3 illustrates an example of the session criteria table, wherein the table defines the encrypted traffic identification policy.

FIG. 4 shows the addition of a new SSL key to the SSL keys table.

FIG. 5 shows the retrieval of an existing SSL key from the SSL keys table.

FIG. 6 illustrates an example of a forwarding filter table which defines the portion of the traffic that needs to be forwarded to an external entity such as an analysis application.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides for a passive SSL probe that offers passive treatment of encrypted traffic flowing between a client and a server. Whenever encrypted traffic is copied towards a network analysis application, it first arrives at the passive SSL probe. The passive SSL probe gathers the sequences of traffic coming from a client (and/or returning from a server), assembles a whole session from the received sequences, and decrypts the assembled session. While decrypting new sequences of traffic, the passive SSL probe of the present invention forwards each decrypted sequence to an external entity such as the analysis applications as if it wasn't encrypted.

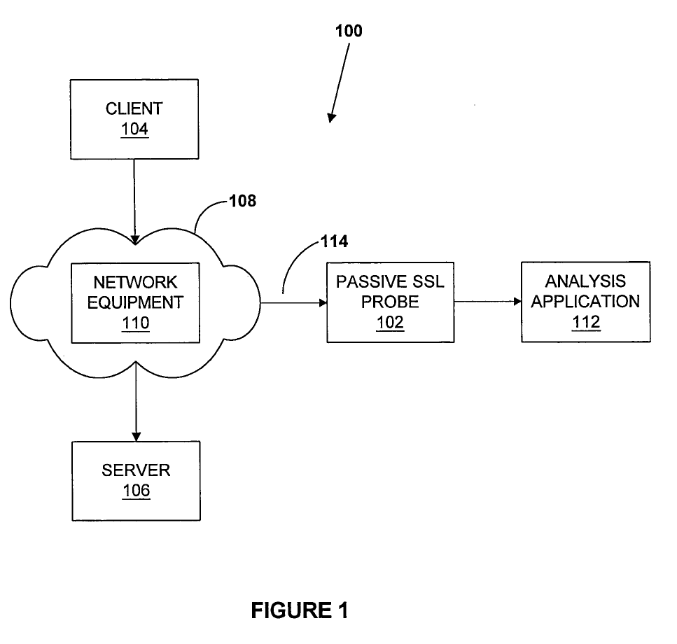

FIG. 1 illustrates system 100 using the present invention's passive SSL probe 102. In this example, client 104 and server 106 communicate via a secure SSL session over network 108. Networking equipment 110 is located along the communication path (between client 104 and server 106) and connects to passive SSL probe 102, which, in turn, is linked to network analysis application 112. Encrypted packets travel from client 104 to server 106, via networking equipment 110. Networking equipment 110 forwards received packets to the server 106, and also forwards a copy of the received packets (with the information identical to what is being sent to the server 106) to the passive SSL probe 102. Similarly, encrypted packets travel from server 106 to client 104, via networking equipment 110. Networking equipment 110 forwards received packets to the client 104, and also forwards a copy of the received packets (with the information identical to what is being sent to the client 104) to the passive SSL probe 102.

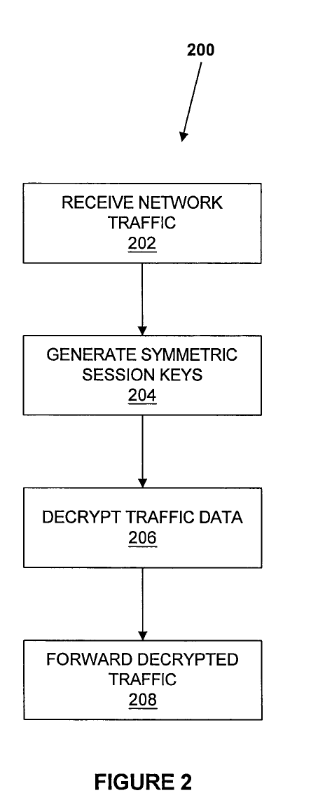

FIG. 2 illustrates method 200 depicting the flow of data through the present invention's passive SSL probe of FIG. 1. The accurate flow of operations is divided into four main parts: (1) receiving network traffic via a receiver (not shown)—202; (2) generating symmetric session keys via a symmetric session keys generator (not shown)—204; (3) decrypting traffic via a decrypter (not shown)—206; and (4) forwarding the decrypted traffic via a forwarder (not shown)—208. First, in step 202, the passive SSL probe receives the copied traffic from the network (more specifically, from network equipment 110 of FIG. 1). The copied traffic includes relevant encrypted sessions and irrelevant non-encrypted data.

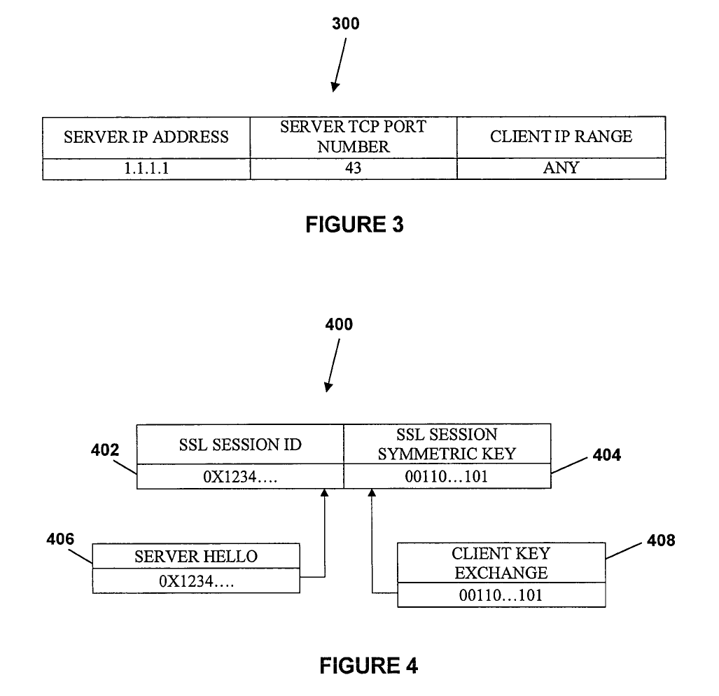

Selection criteria for relevant traffic can include, but should not be limited to: the IP address of the server, TCP port number of the server, client network range, or other identifiers in the packet. FIG. 3 illustrates an example of the session criteria table 300, wherein table 300 defines the encrypted traffic identification policy. Table 300 includes, but should not be limited to, the specification for the server IP, server TCP port number, and client IP address range. For example, in table 300 of FIG. 3, the example policy relates to traffic coming from any client to TCP port 443 of the server 1.1.1.1.

Returning to the discussion of FIG. 2, the passive SSL probe identifies the encrypted part of the traffic and rebuilds the session information. SSL traffic uses TCP for its transport layer, so the probe receives all the packets, classifies them to TCP sessions, and, for each session, separately groups packets from the client and packets from the server. For each such group, the probe organizes the TCP packets by their sequence number and removes any TCP retransmission packet that generates duplicate information. After reconstructing the TCP session, the probe collects the TCP data sequences, which include data representative of any SSL communications, and moves onto the second phase of generating symmetric session keys.

As a part of step 204, the passive SSL probe identifies the SSL handshake part of the SSL communication (where the client and server negotiate a symmetric encryption key). There are two options through which the client and server could negotiate a symmetric encryption key. In the first option, both the client and the server decide to generate a new SSL encryption key, and they perform a full SSL handshake. During this handshake, the client and server negotiate an asymmetric key, using the server's public key for its encryption and the server's private key for its decryption. While the public key is transmitted as part of the negotiation process, the private key is securely kept on the server, and this key must be supplied in advance to the passive SSL probe. Using the private key, the passive SSL probe decrypts the “ClientKeyExchange” message from the client and gets the asymmetric SSL key, together with its attached SSL session ID that passes inside the “ServerHello” message. These are kept in a table in the passive SSL probe memory where each SSL session ID is associated with its corresponding asymmetric SSL key. FIG. 4 shows the addition of a new SSL key to the SSL keys table 400. The key is built from SSL session ID 402 and SSL key 404. The Session ID appears in “ServerHello” message 406, and the SSL key appears in “ClientKeyExchange” message 408.

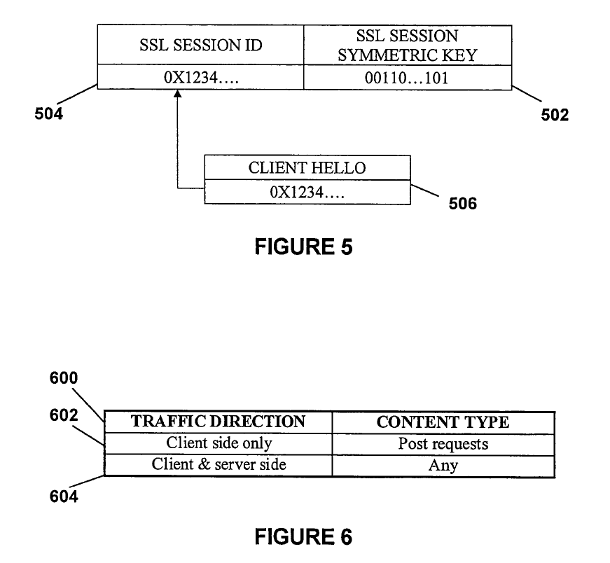

The second option is when both sides decide to reuse a previous asymmetric key. In this scenario, the client and server resume the SSL handshake, passing the information about the SSL session ID that represents the asymmetric SSL key. In this case, the passive SSL probe recognizes the SSL session ID inside the “ClientHello” message and brings the symmetric SSL key that was associated with the SSL session ID from its cached memory. FIG. 5 shows the retrieval of an existing SSL key from the SSL keys table 500. Key value 502 fits the SSL session ID number 504 that appears in “ClientHello” message 506. Together with the encryption key, the server and client also agree on the exact encryption scheme that will be used for the symmetric process, and exchange a pair of random numbers to be used for that SSL transaction. Having the encryption scheme, the random numbers and the asymmetric SSL key, the passive SSL probe moves to the third phase of FIG. 2.

Returning to the discussion of steps 204 and 206 of FIG. 2, the passive SSL probe uses the knowledge about the encryption scheme, the random numbers and the asymmetric SSL key to reconstruct the symmetric encryption key used for this SSL transaction. The passive SSL probe decrypts all of the SSL content that passes between the client and server. Most symmetric encryption schemes advance the encryption key in parallel for the encryption and decryption of both sides of the communication, so the passive SSL encrypts the two sides of the traffic independently in parallel. This generates the actual application data that was encrypted. This data corresponds to the information that the analysis applications (i.e., applications 112 of FIG. 1) require. The passive SSL probe obtains the unencrypted information and moves to the fourth phase of forwarding the decrypted traffic.

In step 208, the passive SSL probe has the complete information regarding content of the secure session. This information should be forwarded to the analysis application. However, it is possible that the analysis application doesn't require all of the content for its operation. The present invention, in one embodiment, provides for a passive SSL probe equipped with (or a passive SSL probe that works in conjunction with) a filter that sorts the information and forwards only the relevant data that the application really needs. The probe uses one of several options in forwarding the traffic to the analysis application.

One embodiment involves forwarding the full communication. In this embodiment, the passive SSL probe transmits the full information as full TCP connections that include the clear information from the encrypted session. Hence, an analysis device does not see any difference from any regular copy of clear session traffic that comes from the network.

In another embodiment, only one side of the communication, either the client's side or the server's side, is forwarded. For example, certain applications simply log the requests from the client and are not interested in the server's replies.

In yet another embodiment, the traffic is filtered according to a mask on the session content (e.g., identifying specific types of requests and forwarding only these sessions). Other options are possible, and it should be clear that the probe can decide which part of the information should be forwarded and what shouldn't, according to the application type. Furthermore, as mentioned above, one specific embodiment allows for all the traffic to be forwarded without any filtering.

FIG. 6 illustrates an example of a forwarding filter table 600 which defines the portion of the traffic that needs to be forwarded to the analysis application. It includes the specification for the traffic direction and content type. Policy 602 is an example of a policy that specifies forwarding of client traffic only, wherein the traffic is HTTP post requests. Policy 604 is an example of a policy that specifies sending all the traffic—in both directions—wherein the traffic includes any content.

In order to have the private keys of the servers, the passive SSL probe imports the keys from a single or from multiple servers before starting to process the copied traffic. These keys are kept in the probe's memory and are used whenever a session is received in which the server with the private key is active. Whenever a new server is added to or removed from the list of copied servers or a new set of keys is set on an existing server, the probe is modified with the key.

The passive SSL probe of the present invention is capable of receiving and transmitting traffic from either a single network interface or from multiple network interfaces. Also, the SSL probe is capable of receiving traffic from a single server or multiple servers and, similarly, is capable of forwarding that traffic to single or multiple analysis applications using any predefined logical relationships. Additionally, the passive SSL probe is capable of using any filtering policy on the traffic it receives to decide what part of that traffic should be and should not be decrypted. Hence, it is able to use various filtering policies to decide what part of the originally received traffic or the decrypted traffic should be forwarded to one or more of the analysis applications. The various phases can be implemented either in software or in hardware and can also be divided between multiple processors and units.

Furthermore, the present invention includes a computer program code based product, which is a storage medium having program code stored therein which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

Implemented in computer program code based products are software modules for: (a) aiding in the reception of data packets corresponding to encrypted data, wherein the encrypted data is forwarded to an SSL probe from network equipment that replicates encrypted data corresponding to secure communication sessions between a client and server; (b) ordering said received data packets for a TCP session and reconstructing the session content; (c) identifying SSL handshake information from the session content; (d) identifying an encryption scheme and a symmetric session key from the identified SSL handshake information; (e) decrypting the session content, wherein the decryption is based upon the identified encryption scheme and the identified symmetric key; and (f) forwarding the identified unencrypted session content to an external entity, such as an analysis application.

### CONCLUSION

A system and method has been shown in the above embodiments for the effective implementation of a passive SSL decryption scheme and a probe implementing the same. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by type of filter used in the SSL probe, type of analysis application, type of network used for communications between client and server, type of encryption algorithm, software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of communication/networking algorithms.

1. A method for passive probing forwarded one or more TCP communication sessions between a client and a server, said method comprising the steps of:
a. receiving forwarded data packets corresponding to said TCP communication sessions;
b. ordering said received data packets and reconstructing session content for each of said one or more sessions; and
c. forwarding said reconstructed session content to an external entity.

2. A method as per claim 1, wherein at least one of said communication sessions is encrypted, and, for each encrypted session, said method additionally comprising the steps of:
d. identifying, prior to said forwarding step, an encryption scheme and a session key from said reconstructed content; and
e. decrypting said session content based upon said identified encryption scheme and said session key,
wherein said forwarded session content in (c) is said decrypted session content.

3. A method as per claim 2, wherein said at least one encrypted communication session is encrypted via the secure socket layer (SSL) protocol.

4. A method as per claim 1, wherein said method further comprises the step of filtering said reconstructed session content to isolate information pertinent to said external entity, and in step (c), forwarding said isolated information pertinent to said external entity.

5. A method as per clam 4, wherein said isolated content represents unencrypted communications from said client.

6. A method as per claim 4, wherein said isolated content represents unencrypted communications from said server.

7. A method as per claim 1, wherein said external entity is a network data analysis application.

8. A passive secure socket layer (SSL) probe working in conjunction with network equipment and an external entity, said network equipment forwarding a copy of encrypted data in a secure communication session between a client and a server to said SSL probe, said SSL probe comprising:
a. a receiver receiving data packets corresponding to said forwarded encrypted data from said network equipment, ordering said received data packets for a TCP session, and reconstructing the session content;
b. a symmetric session key generator receiving said session content for said TCP session from said receiver, identifying SSL handshake information from said session content, and identifying an encryption scheme and a symmetric session key using said SSL handshake information;
c. a decrypter decrypting said session content, said decryption based upon said identified encryption scheme and said identified symmetric key; and
d. a forwarder forwarding said decrypted session content to said external entity.

9. A passive secure socket layer (SSL) probe as in claim 8, wherein said forwarder further comprises a filter filtering said generated unencrypted session content to isolate information pertinent to said external entity, and said forwarder forwarding said isolated information pertinent to said external entity.

10. A passive secure socket layer (SSL) probe as in claim 8, wherein said forwarder further comprises a filter filtering said generated unencrypted session content to isolate unencrypted communications from said client, and said forwarder forwarding said isolated unencrypted communications from said client.

11. A passive secure socket layer (SSL) probe as in claim 8, wherein said external entity is a network data analysis application.

12. A passive secure socket layer (SSL) probe as in claim 8, wherein said forwarder further comprises a filter filtering said generated unencrypted session content to isolate unencrypted communications from said server, and said forwarder forwarding said isolated unencrypted communications from said server.

13. A method for passive decryption of encrypted data, said method as implemented in a passive secure socket layer (SSL) probe comprising the steps of:
a. receiving data packets corresponding to said encrypted data, said encrypted data forwarded to said SSL probe from network equipment, said network equipment replicating encrypted data in secure communication sessions between a client and a server, and said forwarded data corresponding to said secure communication sessions;
b. ordering said received data packets of a TCP session and reconstructing the session content;
c. identifying SSL handshake information from said session content;
d. identifying an encryption scheme and a symmetric session key using said identified SSL handshake information;
e. decrypting said session content, said decryption based upon said identified encryption scheme and said identified symmetric key; and
f. forwarding said decrypted session content to an external entity.

14. A method for passive decryption of encrypted data, as in claim 13, wherein said method further comprises the step of filtering said decrypted session content to isolate information pertinent to said external entity, and, in step (f), forwarding said isolated information pertinent to said external entity.

15. A method for passive decryption of encrypted data, as in claim 13, wherein said method further comprises the step of filtering said decrypted session content to isolate unencrypted communications from said client, and, in said step (f), forwarding said isolated unencrypted communications from said client.

16. A method for passive decryption of encrypted data, as in claim 13, wherein said method further comprises the step of filtering said decrypted session content to isolate unencrypted communications from said server, and, in said step (f), forwarding said isolated unencrypted communications from said server.

17. A method for passive decryption of encrypted data, as in claim 13, wherein said external entity is a network data analysis application.

18. An article of manufacture comprising a computer usable medium having computer readable program code embodied therein providing passive decryption of encrypted data, said medium comprising:
a. computer readable program code aiding in receiving data packets corresponding to said encrypted data, said encrypted data forwarded to a Secure Sockets Layer (SSL) probe from network equipment, said network equipment replicating encrypted data in secure communication sessions between a client and a server, and said forwarded data corresponding to said secure communication sessions;
b. computer readable program code ordering said received data packets of a TCP session and reconstructing the session content;
c. computer readable program code identifying SSL handshake information from said session content;
d. computer readable program code identifying an encryption scheme and a symmetric session key using said identified SSL handshake information;
e. computer readable program code decrypting said session content, said decryption based upon said identified encryption scheme and said identified symmetric key; and
f. computer readable program code aiding in forwarding said decrypted session content to an external entity.

19. An article of manufacture, as per claim 18, wherein said medium further comprises computer readable program code filtering said decrypted session content to isolate information pertinent to said external entity, and, in step (f), computer readable program code aiding in forwarding said isolated information pertinent to said external entity.

20. An article of manufacture, as in claim 18, wherein said medium further comprises computer readable program code filtering said decrypted session content to isolate unencrypted communications from said client, and, in step (f), computer readable program code aiding in forwarding said isolated unencrypted communications from said client.

21. An article of manufacture, as in claim 18, wherein said medium further comprises computer readable program code filtering said decrypted session content to isolate unencrypted communications from said server, and, in step (f), computer readable program code aiding in forwarding said isolated unencrypted communications from said server.

22. A method for passive decryption of encrypted data, said method as implemented in a passive secure socket layer (SSL) probe comprising the steps of:
receiving data packets forwarded to said SSL probe from a network equipment, said network equipment replicating data in a communication session between a client and a server;
in said received data packets, selecting and isolating data packets corresponding to encrypted communication sessions;
ordering data packets in said isolated data packets of a TCP session and reconstructing session content;
identifying SSL handshake information from said session content;
identifying an encryption scheme and a symmetric session key using said identified SSL handshake information;
decrypting said session content, said decryption based upon said identified encryption scheme and said identified symmetric key;
filtering said decrypted session content to isolate information pertinent to said external entity; and
forwarding said filtered information pertinent to said external entity.

23. A method as per claim 22, wherein said step of selecting data packets corresponding to encrypted communication sessions is based upon any of the following selection criteria: IP address of the server, TCP port number of the server, client network range, or an identifier in a data packet.

24. A method as per claim 22, wherein said external entity is a network data analysis application.

25. A passive secure socket layer (SSL) probe working in conjunction with network equipment and an external entity, said network equipment forwarding a copy of encrypted data in a secure communication session between a client and a server to said SSL probe, said SSL probe comprising:
a receiver receiving data packets corresponding to said forwarded encrypted data from said network equipment, ordering said received data packets of a TCP session and reconstructing session content;
a symmetric session key generator receiving said session content from said receiver, identifying SSL handshake information from said session content, and identifying an encryption scheme and a symmetric session key using said SSL handshake information;
a decrypter decrypting said session content, said decryption based upon said identified encryption scheme and said identified symmetric key;
a filter isolating information pertinent to said external entity via filtering said decrypted session content; and
a forwarder forwarding said isolated information pertinent to said external entity.

26. A passive secure socket layer (SSL) probe, as per claim 25, wherein said external entity is a network data analysis application.

27. Network equipment facilitating the flow of encrypted data in a secure communication session between a client and a server, said network equipment comprising:
a receiver receiving encrypted data packets corresponding to said secure communication session, copying data packets corresponding to said secure session, and for each secure session: ordering said copied data packets, and reconstructing the session content;
a session key generator receiving said reconstructed session content from said receiver, identifying SSL handshake information from said session content, and identifying an encryption scheme and a session key using said SSL handshake information;
a decrypter decrypting said session content, said decryption based upon said identified encryption scheme and said identified session key; and
a forwarder forwarding said received encrypted data packets to its intended destination and forwarding said decrypted session content to an external entity.

28. Network equipment as per claim 27, wherein said external entity is a network data analysis application.

29. Network equipment as per claim 27, wherein said forwarder further comprises a filter filtering said decrypted session content to isolate information pertinent to said external entity, and said forwarder forwarding said isolated information pertinent to said external entity.

30. Network equipment as per claim 27, wherein said forwarder further comprises a filter filtering said decrypted session content to isolate unencrypted communications from said client, and said forwarder forwarding said isolated unencrypted communications from said client to said external entity.

31. Network equipment as per claim 27, wherein said forwarder further comprises a filter filtering said generated unencrypted session content to isolate unencrypted communications from said server, and said forwarder forwarding said isolated unencrypted communications from said server to said external entity.

32. A method for passive probing of forwarded TCP communication sessions between a client and a server, said method comprising the steps of:
receiving forwarded data packets corresponding to said TCP communication sessions; and
ordering said received data packets and reconstructing session content for each TCP session, and if at least one of said communication sessions is encrypted, then:
identifying an encryption scheme and a session key using said reconstructed session content;
decrypting said session content, said decryption based upon said identified encryption scheme and said identified session key; and
forwarding said decrypted session content to an external entity; else
forwarding said reconstructed session content of to an external entity.
